(19) United States
(12) Patent Application Publication
(10) Pub. No.: US 2003/0043862 A1
(43) Pub. Date: Mar. 6, 2003

(54) Dispersion compensation using optical wavelength locking for optical fiber links that transmit optical signals generated by short wavelength transmitters

(75) Inventors: Lawrence Jacobowitz, Wappingers Falls, NY (US); Casimer Maurice DeCusatis, Poughkeepsie, NY (US)

Correspondence Address: Steven Fischman, Esq., Scully, Scott, Murphy & Presser, 400 Garden City Plaza, Garden City, NY, 11530, US

(73) Assignee: International Business Machines Corporation, Armonk, NY

(21) Appl. No.: 09/944,271

(22) Filed: Aug. 31, 2001

(51) Int. Cl. H01S 3/10; G02B 6/26

(52) U.S. Cl. 372/20; 385/15; 359/161

(57) ABSTRACT

A system and method for precisely controlling the wavelength of short wavelength optical signals being communicated via a fiber optic link in an optical system. The system comprising a configuration of optical filter elements each having a peaked passband function capable of passing short wavelength optical signals, the optical filter elements being in a nested configuration with a first optical filter element having a peaked passband function capable of passing short wavelength optical signals within a first range of wavelengths for input to a next successive optical filter stage; each successive optical filter stage of the nested configuration capable of passing wavelengths within successively narrower wavelength ranges within the first range of wavelengths. A wavelength-locked loop servo-control circuit is provided for enabling real time alignment of a peaked center wavelength of the short wavelength optical signals with the peaked passband function of the first optical filter element of the nested configuration to thereby provide coarse adjustment of the short wavelength optical signals, and iteratively enable real time alignment of a peaked center wavelength of the short wavelength optical signals coarse adjusted at each optical filter stage with a peaked passband function of each immediate successive optical filter element in the next optical filter stage of the nested configuration thereby enabling continuous fine tune adjustment of the short wavelength optical signals within successively narrower wavelength ranges. The fine adjusted short wavelength optical signal output of an optical filter stage is capable of being transmitted over longer optical fiber link distances with reduced dispersion effects.

### BACKGROUND OF THE INVENTION

1. Field of the Invention

The present invention relates generally to optical devices such as lasers, and fiber optic data transmission systems employing the same, and particularly to a novel dispersion compensation technique implementing a wavelength-locked loop servo-control circuit.

2. Description of the Prior Art

As known, many data communication protocols use long wavelength optical transmitters (“LX”) to achieve distances of 10-20 km or more unrepeated. There is also widespread use of short wavelength (“SX”) transmitters because of their lower cost (about ½ the price of LX devices); unfortunately, SX transceivers running at 1 Gbit/s or higher are limited to distances of about 500 meters over standard multimode fiber because of dispersion effects. For example, there is a fundamental limit imposed by Polarization Mode Dispersion (“PMD”) which is a type of pulse dispersion that causes optical pulses to spread as they propagate through fibers, eventually causing intersymbol interference and bit errors. Since the links are dispersion limited, longer distances cannot be achieved by simply increasing the laser output power. Because of the strong interest in SX optics, many companies have introduced special types of multimode optical fiber optimized for SX transmission; this allows distances of up to 1 km to be achieved, but requires installing new fiber. The newer fiber is also about 20-50% more expensive than standard multimode fibers.

It would thus be highly desirable to provide a relatively less expensive way to run SX gigabit links over standard multimode optical fiber by compensating for dispersion.

It is elemental that launching a Gaussian optical pulse through a Gaussian wavelength selective bandpass filter will cause a reduction of the pulse width. However, there is a tradeoff of pulse width vs. optical power required. That is, a higher power transmitter is required, which can be easily achieved with current transceiver designs simply by increasing the laser bias current. However, it is not practical to implement this tradeoff unless a controlled method exists for matching the center wavelength of an arbitrarily chosen laser to the center of a filter passband. Otherwise, the optical loss between the laser and filter becomes too great and any advantages from reducing the pulse width are lost.

It would thus be further highly desirable to provide a system and methodology implementing a novel feedback control loop that would permit the dynamic alignment of a laser center frequency with the Gaussian filter passband such that, there is an acceptable tradeoff between optical power and pulse width, enabling higher power lasers to be used to generate a narrower optical pulse.

### SUMMARY OF THE INVENTION

It is therefore an object of the present invention to provide a dispersion compensation system and methodology that enables the narrowing of the width of optical pulses being launched into the fiber, without resorting to a special type of expensive laser device.

It is another object of the present invention to provide a dispersion compensation system and methodology that enables the narrowing of the width of optical pulses being launched into the fiber and, that ensures that an acceptable tradeoff exists between optical power and pulse width so a higher power laser can be used to generate a narrower optical pulse. The narrower pulses then travel farther in the fiber link before reaching their dispersion limit.

It is a further object of the present invention to provide a dispersion compensation system and methodology that enables the narrowing of the width of optical pulses being launched into the fiber while ensuring acceptable power levels so that existing link distances may be significantly increased, without the need for installing new multimode fibers.

It is still another object of the present invention to provide a servo/feedback loop, referred to as a “wavelength-locked loop,” that provides compensation for wavelength dispersion effects in optical fiber links by ensuring wavelength alignment between the filter bandpass with the center wavelength of the optical signal transmitted through the link.

It is yet a further object of the present invention to provide a dispersion compensation system and methodology that enables the narrowing of the width of optical pulses being launched into the fiber by short wavelength (“SX”) transmitters while increasing the link distances achieved.

Thus, according to the principles of the invention, there is provided a system and method for precisely controlling the wavelength of short wavelength optical signals being communicated via a fiber optic link in an optical system. The system comprising a configuration of optical filter elements each having a peaked passband function capable of passing short wavelength optical signals, the optical filter elements being in a nested configuration with a first optical filter element having a peaked passband function capable of passing short wavelength optical signals within a first range of wavelengths for input to a next successive optical filter stage; each successive optical filter stage of the nested configuration capable of passing wavelengths within successively narrower wavelength ranges within the first range of wavelengths. A wavelength-locked loop servo-control circuit is provided for enabling real time alignment of a peaked center wavelength of the short wavelength optical signals with the peaked passband function of the first optical filter element of the nested configuration to thereby provide coarse adjustment of the short wavelength optical signals, and iteratively enable real time alignment of a peaked center wavelength of the short wavelength optical signals coarse adjusted at each optical filter stage with a peaked passband function of each immediate successive optical filter element in the next optical filter stage of the nested configuration thereby enabling continuous fine tune adjustment of the short wavelength optical signals within successively narrower wavelength ranges. The fine adjusted short wavelength optical signal output of an optical filter stage is capable of being transmitted over longer optical fiber link distances with reduced dispersion effects.

Advantageously, the system and method of the present invention may be employed in short wave FICON, fibre channel, and gigabit Ethernet optical systems over standard multimode fiber.

### BRIEF DESCRIPTION OF THE DRAWINGS

Further features, aspects and advantages of the apparatus and methods of the present invention will become better understood with regard to the following description, appended claims, and the accompanying drawings where:

FIG. 1(a) is a block diagram illustrating the SX two-stage (nested) dispersion compensation system according to the invention;

FIG. 1(b) particularly is a flowchart depicting the state machine and control loops for the two-nested WLL loop case.

FIGS. 2(a) and 2(b) depict examples of underlying wavelength-locked loop system architectures;

FIG. 2(c) is a general block diagram depicting the underlying system architecture for tuning tunable frequency selective devices such as a bandpass filter according to the principles of the present invention;

FIGS. 3(a)-3(c) are signal waveform diagrams depicting the relationship between laser optical power as a function of wavelength for three instances of optic laser signals;

FIGS. 4(a)-4(c) are signal waveform diagrams depicting the laser diode drive voltage dither modulation (a sinusoid) for each of the three waveform diagrams of FIGS. 3(a)-3(c);

FIGS. 5(a)-5(c) are signal waveform diagrams depicting the resulting feedback error signal output of the PIN diode for each of the three waveform diagrams of FIGS. 3(a)-3(c);

FIGS. 6(a)-6(c) are signal waveform diagrams depicting the cross product signal resulting from the mixing of the amplified feedback error with the original dither sinusoid;

FIGS. 7(a)-7(c) are signal waveform diagrams depicting the rectified output laser bias voltage signals which are fed back to adjust the laser current and center frequency;

### DETAILED DESCRIPTION OF PREFERRED EMBODIMENTS

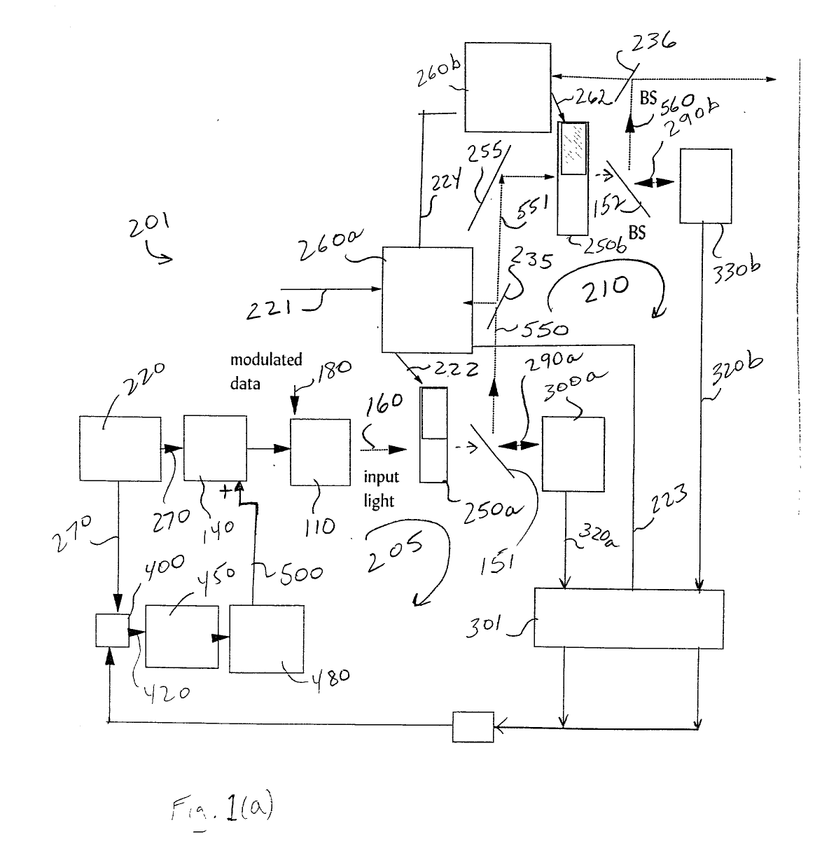

The present invention is directed to dispersion compensation techniques for optical fiber links that transmit optical signals generated by short wavelength (“SX”) transmitters while increasing the link distances achieved. In a preferred embodiment, as will be particularly described with respect to FIG. 1, a novel servo-control loop is employed for narrowing the width of optical pulses being launched into the fiber, without having to resort to a special type of expensive laser device. The controlled dispersion compensation method according to the invention functions to dynamically match the center wavelength of an arbitrarily chosen laser source to the center wavelength of a filter passband in order to minimize the optical loss in the link. In this manner, there is an acceptable tradeoff between optical power and pulse width, so a higher power laser can be used to generate a narrower optical pulse. The narrower pulses then travel farther in the fiber link before reaching their dispersion limit.

The explanations herein discuss both wavelength and frequency, which have a reciprocal relationship (λ=c/f, where c=speed of light), as is well known in the field of optics.

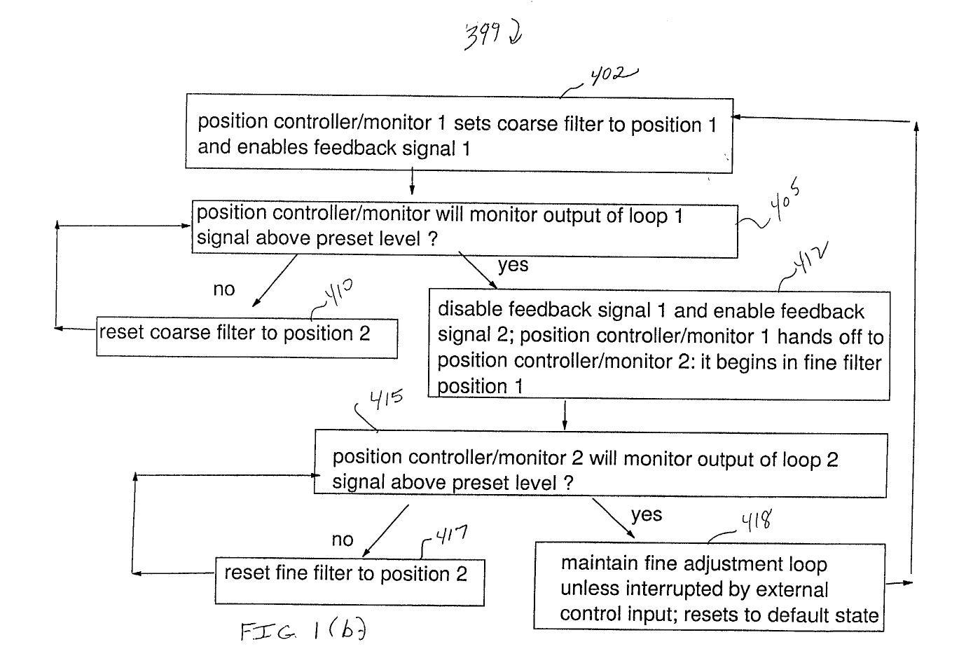

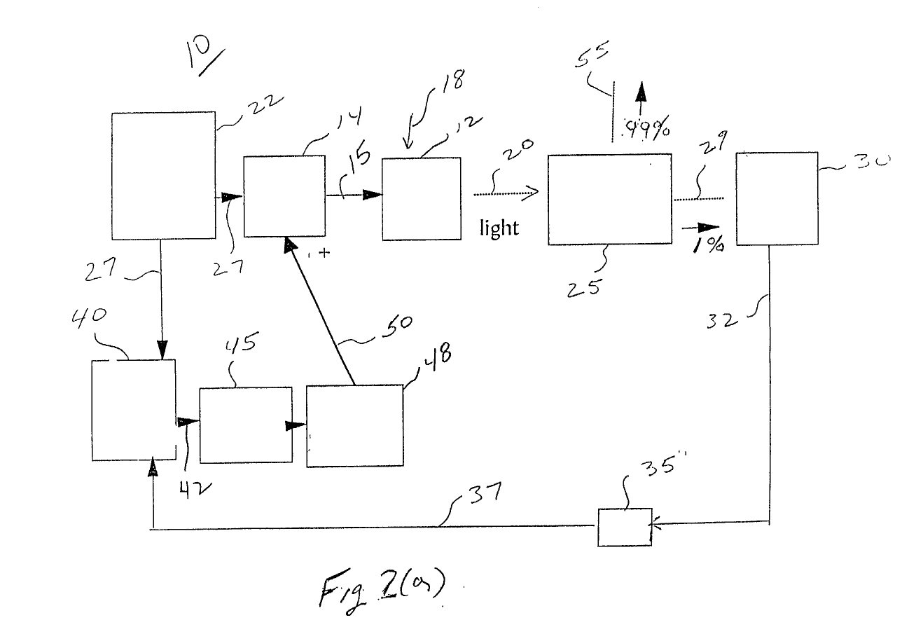

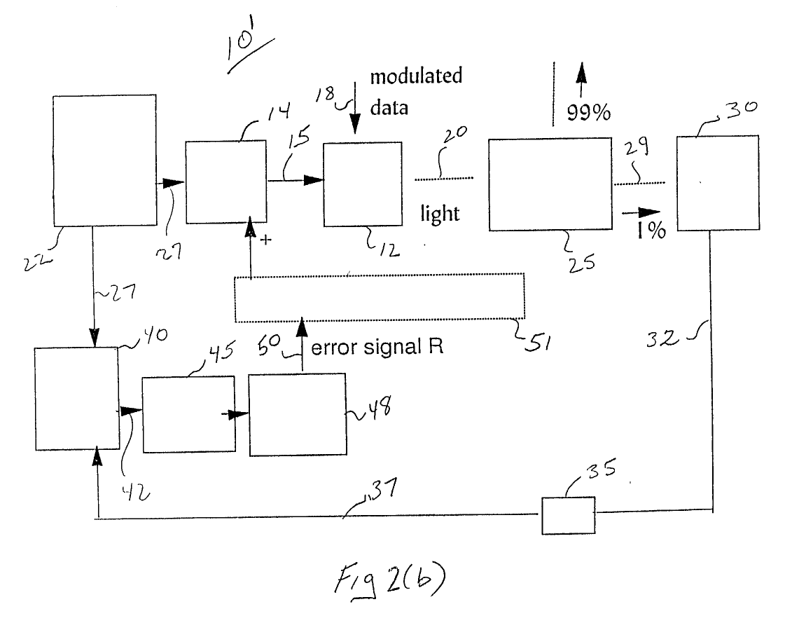

With regard to the dispersion compensation system of the invention, FIG. 2(a) illustrates the novel servo-control system implementing a principle referred to herein as the “wavelength-locked loop” or “lambda-locked loop” (since the symbol lambda is commonly used to denote wavelength). The basic operating principle of the wavelength-locked loop (WLL) is described in greater detail in commonly-owned, co-pending U.S. patent application Ser. No. 09/865,256, entitled APPARATUS AND METHOD FOR WAVELENGTH-LOCKED LOOPS FOR SYSTEMS AND APPLICATIONS EMPLOYING ELECTROMAGNETIC SIGNALS, the whole contents and disclosure of which is incorporated by reference as if fully set forth herein.

Particularly, as described in commonly-owned, co-pending U.S. patent application Ser. No. 09/865,256, and with reference to FIG. 2(a), the wavelength-locked loop principle implements a dither modulation to continuously adjust an electromagnetic signal source characterized as having a peaked frequency spectrum or peaked center wavelength, e.g., a laser light source, so as to track the center of a frequency selective device, e.g. a filter passband. In this manner, optimal power of the signal is transmitted and optimal use is made of the system transmission bandwidth. The principle may be exploited for tuning any light source having a peaked frequency spectrum, and additionally, may be used to tune or adjust transmission properties of frequency selective devices such as tunable filters.

For purposes of description, the basic operating principle of the WLL is shown in FIG. 2(a) which depicts an example optic system 10 including a light source such as laser diode 12 driven with both a bias voltage 15 from a voltage bias circuit 14, and modulated data 18 from a data source (not shown). The laser diode generates an optical (laser light) signal 20 that is received by a bandpass filter 25 or, any frequency selective device including but not limited to: thin film optical interference filters, acousto-optic filters, electro-optic filters, diffraction gratings, prisms, fiber Bragg gratings, integrated optics interferometers, electroabsorption filters, and liquid crystals. The laser diode itself may comprise a standard Fabry Perot or any other type (e.g., Vertical Cavity Surface Emitting (VCSEL)), light emitting diodes, or, may comprise a Distributed Feedback semiconductor laser diode (DFB) such as commonly used for wavelength multiplexing. Preferably, the laser diode emits light in the range of 850 nm to 1550 nm wavelength range. As mentioned, the bandpass filter may comprise a thin film interference filter comprising multiple layers of alternating refractive indices on a transparent substrate, e.g., glass. As further shown in FIG. 2(a), according to the invention, there is an added sinusoidal dither modulation circuit or oscillator 22 for generating a sinusoidal dither modulation signal 27 that modulates the laser bias voltage. The sinusoidal dither signal may be electronically produced, e.g., by varying the current for a laser, or mechanically, by varying the micro-electromechanical system's (MEMS) mirror to vary the wavelength. The dither modulation frequency is on the order of a few kilohertz (kHz) but may range to the Megahertz range. Preferably, the dither modulation frequency is much less than the data rate which is typically on the order of 1-10 GHz. Modulation of the laser diode bias current 15 in this manner causes a corresponding dither in the laser center wavelength. Modulated data is then imposed on the laser, and the optical output passes through the bandpass filter 25. Preferably, the filter 25 is designed to tap off a small amount of light 29, for example, which is incident upon a photo detector receiver device, e.g., P-I-N diode 30, and converted into an electrical feedback signal 32. The amount of light that may be tapped off may range anywhere between one percent (1%) to five percent (5%) of the optical output signal, for example, however, skilled artisans will appreciate any amount of laser light above the noise level that retains the integrity of the output signal including the dither modulation characteristic, may be tapped off. The remaining laser light passes on through the filter 25 to the optical network (not shown). As the PIN diode output 32 is a relatively weak electric signal, the resultant feedback signal is amplified by amplifier device 35 to boost the signal strength. The amplified electric feedback signal 37 is input to a multiplier device 40 where it is combined with the original dither modulation signal 35. The cross product signal 42 that results from the multiplication of the amplified PIN diode output (feedback signal) 37 and the dither signal 35 includes terms at the sum and difference of the dither frequencies. The result is thus input to a low pass filter device 45 where it is low pass filtered and then averaged by integrator circuit 48 to produce an error signal 50 which is positive or negative depending on whether the laser center wavelength is respectively less than or greater than the center point of the bandpass filter. The error signal 50 is input to the laser bias voltage device 15 where it may be added (e.g., by an adder device, not shown) in order to correct the laser bias current 15 in the appropriate direction. In this manner, the bias current (and laser wavelength) will increase or decrease until it exactly matches the center of the filter passband. Alternately, the error signal 50 may be first converted to a digital form, prior to input to the bias voltage device.

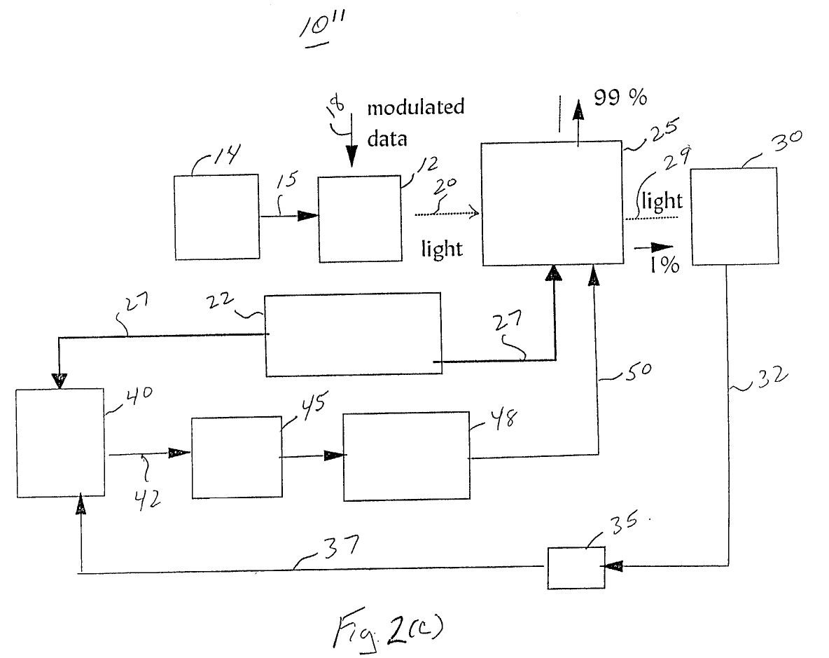

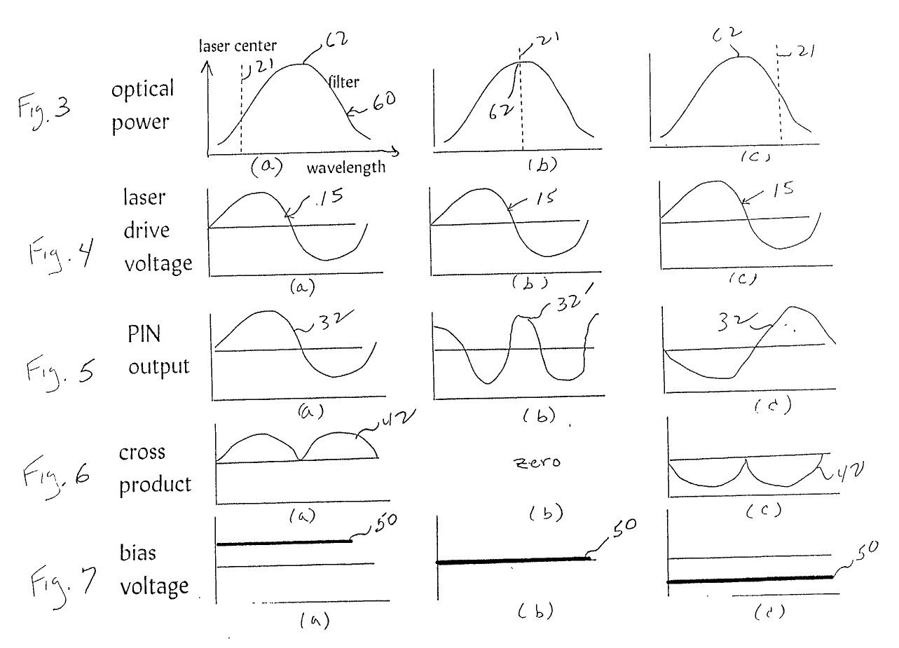

According to one aspect of the invention, the WLL will automatically maintain tracking of the laser center wavelength to the peak of the optical filter. However, in some cases, it may not be desirable to enable laser alignment to the filter peak, e.g., in an optical attenuator. Thus, as shown in FIG. 2(b) which is a system 10′ corresponding to the system 10 of FIG. 2(a), there is provided an optional external tuning circuit, herein referred to as a wavelength shifter device 51, that receives the error signal and varies or offsets it so that the laser center wavelength may be shifted or offset in a predetermined manner according to a particular network application. That is, the wavelength shifter 51 allows some external input, e.g., a manual control element such as a knob, to introduce an arbitrary, fixed offset between the laser center wavelength and the filter peak. It should be understood that, as described in commonly-owned, co-pending U.S. patent application Ser, No. 09/865,256, the WLL servo-control system may be implemented for tuning tunable frequency selective devices such as a bandpass filter for a variety of optical network applications, including optical gain control circuits, such as provided in the present invention. Thus, in the embodiment depicted in FIG. 2(c), the system 10″ comprises similar elements as system 10 (of FIG. 2(a)) including a bias voltage generator device 14 for applying a bias signal 15 to the laser diode 12 for generating an optical signal 20 having a peaked spectrum function. This signal 20 is input to a tunable frequency selective device 25, e.g., a tunable bandpass filter. As shown in FIG. 2(c), however, the sinusoidal dither/driver device 22 is implemented for modulating the peak center frequency of filter pass band with a small dither signal 27. A small amount of light 29 is tapped off the output of the filter 25 for input to the photodetector device, e.g., PIN diode 30, where the optical signal is converted to electrical signal 32, amplified by amplifier device 35, and input to the mixer device 40 which additionally receives the dither signal 27. The mixer device generates the vector cross product 42 of the amplified feedback signal 37 with the dither signal 27 and that result is low-pass filtered, and smoothed (e.g., integrated) by integrator device 48 to provide error signal 50, in the manner as will be discussed herein with reference to FIGS. 3-7. This error signal 50 may be a bi-polar signal and may be used to dynamically adjust the peak center frequency of the filter passband until it matches the center frequency of the laser signal input 20.

The operating principle of the WLL is further illustrated in the timing and signal diagrams of FIGS. 3-7. FIGS. 3(a)-3(c) particularly depicts the relationship between laser optical power as a function of wavelength for three instances of optic laser signals: a first instance (FIG. 3(a)) where the laser signal frequency center point 21 is less than the bandpass function centerpoint as indicated by the filter bandpass function 60 having centerpoint 62 as shown superimposed in the figures; a second instance (FIG. 3(b)) where the laser frequency center point 21 is aligned with the bandpass function centerpoint 62; and, a third instance (FIG. 3(c)) where the laser frequency center point 21 is greater than the bandpass function centerpoint 62. In each instance, as depicted in corresponding FIGS. 4(a)-4(c), the laser diode drive voltage signal 15 is shown dithered (a sinusoid) resulting in the laser wavelength dithering in the same manner. The dithered laser diode spectra passes through the filter, and is converted to electrical form by the PIN diode 30. In each instance of the laser signals depicted in FIGS. 3(a) and 3(c) having frequency centerpoints respectively less than and greater than the band pass filter centerpoint, it is the case that the dither harmonic spectra does not pass through the frequency peak or centerpoint of the bandpass filter. Consequently, the resulting output of the PIN diode is an electric sinusoidal signal of the same frequency as the dither frequency such as depicted in corresponding FIGS. 5(a) and 5(c). It is noted that for the laser signals at frequencies below the peak (FIG. 3(a)) the feedback error signal 32 corresponds in frequency and phase to the dither signal (FIG. 5(a)), however for the laser signals at frequencies above the peak (FIG. 3(c)) the feedback error signal 32 corresponds in frequency but is 180° opposite phase of the dither signal (FIG. 5(c)). Due to the bipolar nature of the feedback signal (error signal) for cases when the laser signal centerpoint is misaligned with the bandpass filter centerpoint, it is thus known in what direction to drive the laser diode (magnitude and direction), which phenomena may be exploited in many different applications. For the laser signal depicted in FIG. 3(b) having the laser frequency center point aligned with the bandpass function centerpoint, the dither harmonic spectra is aligned with and passes through the frequency peak (maximum) of the bandpass filter twice. That is, during one cycle (a complete round trip of the sinusoid dither signal), the dither signal passes though the centerpoint twice. This results in a frequency doubling of the dither frequency of the feedback signal 32, i.e., a unique frequency doubling signature, as depicted as PIN diode output 32′ in FIG. 5(b) showing an feedback error signal at twice the frequency of the dither frequency.

Thus, in each instance, as depicted in corresponding FIG. 5(b), the resulting feedback signal exhibits frequency doubling if the laser center wavelength is aligned with the filter center wavelength; otherwise it generates a signal with the same dither frequency, which is either in phase (FIG. 5(a)) or out of phase (FIG. 5(c)) with the original dither modulation. It should be understood that, for the case where there the laser center frequency is misaligned with the bandpass filter peak and yet there is exhibited partial overlap of the dither spectra through the bandpass filter peak (i.e., the centerpoint peak is traversed twice in a dither cycle), the PIN diode will detect partial frequency doubling laser at opposite phases depending upon whether the laser center frequency is inboard or outboard of the filter center frequency. Thus, even though partial frequency doubling is detected, it may still be detected from the feedback signal in which direction and magnitude the laser signal should be driven for alignment.

Referring now to FIGS. 6(a) and 6(c), for the case when the laser and filter are not aligned, the cross product signal 42 resulting from the mixing of the amplified feedback error with the original dither sinusoid is a signed error signal either at a first polarity (for the laser signals at frequencies below the bandpass filter centerpoint), such as shown in FIG. 6(a) or, at a second polarity (for the laser signals at frequencies above the bandpass filter centerpoint), such as shown in FIG. 6(c). Each of these signals may be rectified and converted into a digital output laser bias voltage signal 48 as shown in respective FIGS. 7(a) and 7(c), which are fed back to respectively increase or decrease the laser current (wavelength) in such a way that the laser center wavelength moves closer to the bandpass filter centerpoint. For the case when the laser and filter are aligned, the cross product generated is the frequency doubled signal (twice the frequency of the dither) as shown in the figures. Consequently, this results in a 0 V dc bias voltage (FIG. 7(b)) which will maintain the laser frequency centerpoint at its current wavelength value.

The use of a wavelength-locked loop to compensate for wavelength dispersion effects by actively aligning the filter peaked bandpass function, with the center wavelength of the laser signal provided by an SX transmitter, is shown in the FIG. 1(a). As is understood to skilled artisans, most short wave (SX) laser diodes typically offer a broad spectral width, making them inherently less coherent than their long wavelength (LX) counterparts. Furthermore, the center wavelength of these SX laser diodes may vary over a broad range, typically between about 780-860 nm, as opposed to long wave (LX) lasers which might confine their center wavelength to a range only of about 5-10 nm wide. For these reasons, a single optical filter is not a practical method for implementing pulse width compression. That is, the optical filter has to offer an unusually wide range of center wavelengths and a broad spectral width, so the resulting pulse compression would be minimal. To avoid this problem, a two-stage dispersion compensation system with a cascade of two wavelength locked loops, is provided as depicted in the system 201 of FIG. 1.

Generally, as shown in FIG. 1, a first stage WLL loop 205 performs a coarse alignment between the input laser signal 160 output from a short wave (SX) laser diode and a two-level coarse optical filter 250a having a first peaked passband function in the 780-810 nm band and a second peaked passband function in the 810-860 nm band. If this results in a good alignment (as determined by the optical power level emerging from the first loop, which is monitored by a first photodiode 300a, then the output light signal is automatically directed into a second stage WLL loop 210 which implements a second fine adjust filter 250b for fine tuning the wavelength range to within 10 nm. If the first filter results in a poor alignment, then the system detects this and automatically changes the optical filter to obtain coarse alignment within the 810-860 nm band. Subsequently, a fine adjustment is made to limit the output range to within 10 nm in the second loop. In this manner, output SX transmitter signal transmission results may be obtained which are as good as if an LX transmitter was used.

While operation of a single wavelength-locked loop is described herein with reference to FIGS. 2(a) through 7, the wavelength dispersion compensation technique for SX transmitters implementing the cascaded two-stage WLL principle as illustrated in FIG. 1(a) employs a sinusoidal dither signal generator 220 that provides a dither oscillation signal 270 for input to a bias voltage control circuit 140 that enables dither modulation of the optical signal 160 output from an optical signal generator 110, e.g., the SX laser diode device. Thus, the nominal center wavelength of the laser signal 160 is dithered by a low frequency (e.g., 1 kHz or less) dither oscillator source driving the semiconductor laser's bias voltage. The SX laser diode is additionally direct current modulated with data 180. Thus, the light 160 passing through the first coarse optical filter 250a having a peaked passband function is intensity modulated by both these signals. The optical output passes through the optical filter (having a Gaussian peaked response), however, as mentioned, generally, the center wavelength of the optical signal 160 is misaligned with the center wavelength of the coarse filter 250a.

According to a preferred embodiment, a first power monitor and position control device 260a is provided that enables the control of the first coarse filter 250a and monitoring of a feedback from the first WLL loop 205 as will now be described with respect to FIG. 1(b). FIG. 1(b) particularly is a flowchart 399 depicting the state machine and control loops for the two-nested WLL loop case. As illustrated in FIG. 1(b), the first step 402 is to generate an external control signal 221 for directing the position controller/monitor 260a to generate control signal 222 for setting coarse filter 250a to a first position providing the first peaked passband function, e.g., in the 780-810 nm range. The external control signal 221 additionally directs the position controller/monitor 260a to generate control signal 223 for enabling monitoring of the first electric feedback signal output of photodiode 300a. Particularly, control signal 223 is input to feedback enable/disable circuit 301 to pass either one of the electrical feedback signals 320a, 320b resulting from processing within the respective first WLL 205 or second WLL loop 210.

Referring back to FIG. 1(a), the output of the filter passes through an optical splitter device 151 which consists of a fusion splice that taps off a small amount 290a of the optical power, e.g., 1%, which is diverted to the photodetector device 300, e.g., a P-I-N diode. The photodetector 300 converts the tapped optical signal into the first electrical feedback signal 320a that is proportional to the intensity modulation of the light. It is understood that the amount of light that may be tapped off may range anywhere between one percent (1%) to five percent (5%) of the optical output signal, however, skilled artisans will appreciate any amount of laser light above the noise level that preserves the modulation characteristics in the cascaded WLL system, may be tapped off (i.e., less than 1%). This signal 320a is fed back to an electronic circuit including an amplifier 350 which amplifies the signal, and a mixer device 400, which multiplies it with the original dither oscillator signal 270 to produce their vector cross product. The resulting signal 420 is then filtered by low pass filter device 450, and integrated and digitized by integrator device 480 which results in error control signal 500 which represents both the magnitude by which the laser and filter center wavelength are misaligned and the direction in which the feedback signal must be corrected to properly align with the filter. For example, the error signal may be a zero value if the laser signal center wavelength and the center wavelength of the peaked passband coarse optical filter are properly aligned, i.e., the cross product is frequency doubled, which averages out to zero when passing through the electronics. If, according to the WLL principles, the laser and coarse filter center frequency are not aligned, the signal 500 provides both the amount by which the bias signal applied to the laser diode must be adjusted to realign them and the direction (increase or decrease) in which the center wavelength of the source SX laser output is to move to align with the coarse filter. When the two center wavelengths are in alignment, the feedback error signal is frequency doubled and there is no change to the laser center wavelength. In this manner, the laser and filter center wavelengths are kept in alignment with each other through a dynamic feedback loop.

As shown in FIG. 1(a), the optical signal 550 remaining after tapping of small portion 290a of the optical signal for feedback is directed to the first position controller/monitor 260a for power monitoring. A beamsplitter device 235 is provided for directing a portion of the optical signal 550 to power monitor circuitry (not shown) provided in the first position controller/monitor 260a which continuously monitors the power of the optical signal output from the first WLL loop 205. In the operation depicted in FIG. 1(b), at step 405, a determination is made as to whether the power of the remaining portion 550 of the optical signal is greater than a preset level. If the power of the remaining portion 550 of the optical signal is not greater than a preset level as determined by the power monitor circuitry, then this means that the first coarse filter is not properly set and, at step 407, results in the resetting of the first coarse filter to the second position and the process returns to step 405 for continued power monitoring. That is, as shown in FIG. 1(a), the first position controller/monitor 260a is programmed to generate control signal 222 for setting coarse filter 250a to its second position providing a peaked passband function, e.g., in the 810-860 nm range. The external control signal 221 additionally directs the first position controller/monitor 260a to maintain control signal 223 for enabling monitoring of the first electric feedback signal output of photodiode 300a. In this manner, the first WLL may be again implemented to generate error signal 500 for moving the center wavelength of the source SX laser output into alignment with the second peaked passband first coarse filter setting. When the two center wavelengths are in alignment, the feedback error signal is frequency doubled and there is no change to the laser center wavelength. In this manner, the laser and filter center wavelengths are kept in alignment with each other through a dynamic feedback loop. It should be understood that the preset power level as detected by the power monitor circuits of the first position controller/monitor 260a corresponds to a power attainable by the SX laser diode that will result in no dispersion loss for the length of optical fiber in which the signal is communicated. Signal levels for the power monitor are pre-set for the desired application. These levels may be different depending upon the application (FICON™, Gigabit Ethernet, etc) and are pre-set when the WLL is constructed.

Returning to FIG. 1(b), at step 405, if the power of the remaining portion 550 of the optical signal is above the preset level as determined by the power monitor circuitry, then this means that the first coarse filter is properly set and, at step 412 additional control is provided for implementing the second WLL loop 210 for fine tuning the laser wavelength for optimal transmission through the system. Consequently, according to step 412, and as shown in FIG. 1(a), the first position controller/monitor 260a is programmed to generate a signal 224 for handing-off control to a second position controller/monitor 260b and to modify control signal 223 for enabling enable disable circuitry 301 to enable monitoring of the second electric feedback signal output of photodiode 300b. Particularly, the second position controller/monitor 260b generates a control signal 262 for setting fine adjust filter 250b to a first position providing a first peaked passband function that effectively limits the output range to within 10 nm of the centerwavelength determined from the first WLL loop 205. As an example, when coarse filter 250a is adjusted to its second position providing a broad peaked passband function, e.g., in the 810-860 nm range, the fine adjust filter 250b may have a narrower passband, e.g., 820-830 nm.

The second WLL loop 210 thus operates as follows: the remaining optical signal 551 output from the first loop that passes through beamsplitter device 235 is deflected off mirror 255 and input to the fine adjust filter device 250b. The output of the filter 250b passes through an optical beam splitter 152 where a small portion 290b is tapped off as in the first WLL loop operation for detection by photodiode element 330b. which converts the tapped optical signal into the second electrical feedback signal 320b that is proportional to the intensity modulation of the light. This signal 320b is feedback to the electronic circuit including amplifier 350 which amplifies the signal, and the mixer device 400, which multiplies it with the original dither oscillator signal 270 to produce their vector cross product. The resulting signal 420 is then filtered by low pass filter device 450, and integrated and digitized by integrator device 480 which results in error control signal 500 which represents both the magnitude by which the laser and second filter center wavelength are misaligned and the direction in which the feedback signal must be corrected to properly align with the filter. For example, the error signal may be a zero value if the laser signal center wavelength and the center wavelength of the peaked passband coarse optical filter are properly aligned, i.e., the cross product is frequency doubled, which averages out to zero when passing through the electronics. If, according to the WLL principles, the laser and coarse filter center frequency are not aligned, the signal 500 provides both the amount by which the bias signal applied to the laser diode must be adjusted to realign them and the direction (increase or decrease) in which the center wavelength of the source SX laser output is to move to align with the coarse filter. When the two center wavelengths are in alignment, the feedback error signal is frequency doubled and there is no change to the laser center wavelength. In this manner, the laser and filter center wavelengths are kept in alignment with each other through both dynamic feedback loops 205, 210.

As shown in FIG. 1(a), the optical signal 560 remaining after tapping off a small portion 290b of the optical signal for feedback is directed to the second position controller/monitor 260b for power monitoring thereof. A beamsplitter device 236 is provided for directing a portion of the optical signal 560 to power monitor circuitry (not shown) provided in the second position controller/monitor 260b for monitoring the power of the optical signal output from the second WLL loop 210. Referring back to FIG. 1(b), at step 415, a determination is made as to whether the power of the remaining portion 560 of the optical signal is greater than a preset level. If the power of the remaining portion 560 of the optical signal is not greater than a preset level as determined by the power monitor circuitry, then this means that the second fine adjust filter is not properly set and, at step 417, results in the resetting of the fine adjust filter to the second position and the process returns to step 415 for continued power monitoring. That is, as shown in FIG. 1(a), the second position controller/monitor 260b is programmed to generate control signal 262 for setting fine adjust filter 250b to its second position providing the narrower peaked passband function, e.g., in the 5-10 nm range within the coarse adjusted range of the first filter 250a. The external control signal 221 additionally directs the first position controller/monitor 260b to maintain control signal 223 for enabling monitoring of the second electric feedback signal output of photodiode 300b. In this manner, the second WLL may be again implemented to generate error signal 500 for moving the center wavelength of the source SX laser output into alignment with the second peaked passband of the fine adjust filter setting. When the two center wavelengths are in alignment, the feedback error signal is frequency doubled and there is no change to the laser center wavelength. In this manner, the laser and filter center wavelengths are kept in alignment with each other through both dynamic feedback loops 205,210. It should be understood that the preset power level as detected by the power monitor circuits of the second position controller/monitor 260b likewise corresponds to a power attainable by the SX laser diode that will result in no dispersion loss for the length of optical fiber in which the optical signal is communicated.

Returning to FIG. 1(b), at step 415, if the power of the remaining portion 560 of the optical signal is above the preset level as determined by the power monitor circuitry, then this means that the second fine adjust filter is properly set and, at step 418 the fine adjustment loop is maintained at the current settings until interrupted by the external control input 221. That is, the external control signal may be used to reset the loops on demand. It should be understood that the state of the laser diode and power monitor circuits additionally becomes a default setting and the process. It should be further understood that the principles of the invention may be extended to nest an arbitrary number of feedback loops if desired, although the control feedback loops and state machines become increasingly complex.

According to one embodiment of the invention, the preset power level thresholds for the respective power monitor circuits 260a, 260b in each respective loop 205, 210 may be on the order of about −5 dBm or −3 dBm respectively. However, it is understood that the preset power thresholds are determined by the requirements of a particular optical system. For example, if it is intended to run short wavelength optical signals over a very long distance, the threshold may be set higher to get more light power into the fibers; however, if it is intended to run short wavelength optical signals over a shorter link that is dispersion limited, not loss limited, the thresholds may be set lower.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Having thus described our invention, what we claim as new, and desire to secure by Letters Patent is:

1. A dispersion compensation system for an optical system comprising:
a short wavelength optical signal generator for providing an optical signal capable of being communicated via a fiber optic link in an optical network, said optical signal characterized as having an operating center wavelength;
a first optical filter element having a peaked passband function capable of passing short wavelength optical signals within a first range of wavelengths;
a wavelength-locked loop servo-control circuit for enabling real time alignment of a peaked center wavelength of said short wavelength optical signals with said peaked passband function of said first optical filter element to thereby provide coarse adjustment of said short wavelength optical signals; and,
a second optical filter element having a peaked passband function capable of passing short wavelength optical signals within a narrower wavelength range within said first range of wavelengths, said wavelength-locked loop servo-control circuit further enabling real time alignment of a peaked center wavelength of said coarse adjusted short wavelength optical signals with said peaked passband function of said second optical filter element to thereby provide fine adjustment of said short wavelength optical signals within said narrower wavelength range, said fine adjusted short wavelength optical signals capable of being transmitted over longer distances with reduced dispersion effects.

2. The dispersion compensation system for an optical system as claimed in claim 1, wherein said wavelength-locked loop servo-control circuit comprises:
a mechanism for applying a dither modulation signal at a dither modulation frequency to said short wavelength optical signal to generate a dither modulated shortwave optical signal through said first adjustable optical filter element;
a mechanism for converting a portion of dither modulated short wavelength optical signals to be coarse adjusted into a first electric feedback signal and for converting a portion of dither modulated short wavelength optical signals to be fine adjusted into a second electric feedback signal;
a gate device responsive to a first control signal for selecting said first electric feedback signal when performing a coarse adjustment and, responsive to a second control signal for selecting said second electric feedback signal when performing said fine adjustment;
mechanism for continuously comparing a selected first or second feedback signal with said dither modulation signal and generating a respective error signal, said error signal representing one of a difference between a frequency characteristic said selected first feedback signal and a dither modulation frequency when performing coarse adjustment of said short wavelength optical signals, or, a difference between a frequency characteristic of said selected second feedback signal and said dither modulation frequency when performing fine adjustment of said short wavelength optical signals; and,
mechanism responsive to an error signal for adjusting the peak spectrum function of said short wavelength optical signal according to said error signal, wherein said center wavelength of said short wavelength optical signals are adjusted for maximum power transmission through said respective first and second optical filter elements.

3. The dispersion compensation system for an optical system as claimed in claim 2, wherein said center wavelength of said coarse adjusted short wavelength optical signals become aligned when said frequency characteristic of said first feedback signal is two times said dither modulation frequency and, said center wavelength of said fine adjusted short wavelength optical signals become aligned when said frequency characteristic of said second feedback signal is two times said dither modulation frequency.

4. The dispersion compensation system for an optical system as claimed in claim 2, wherein said short wavelength optical signal is a laser signal, said short wavelength optical signal generator comprising:
a short wavelength laser diode device for generating said short wavelength optical signal; and,
a bias voltage circuit for providing a bias signal to said short wavelength laser diode device for generating said short wavelength optical signal.

5. The dispersion compensation system for an optical system as claimed in claim 4, wherein said device for applying a dither modulation to said bias signal is a sinusoidal dither circuit for generating a sinusoidal dither modulation signal of a predetermined frequency.

6. The dispersion compensation system for an optical system as claimed in claim 2, wherein said first and second optical filter elements are adjustable, said first optical filter adjusted to provide a peaked passband function capable of passing short wavelength optical signals within a second range of wavelengths during said coarse adjustment and, said second optical filter element adjusted to provide a peaked passband function capable of passing short wavelength optical signals within a narrower wavelength range within said second range of wavelengths during said fine adjustment.

7. The dispersion compensation system for an optical system as claimed in claim 6, further comprising:
first power monitor circuit responsive to said first control signal for monitoring power of said short wavelength optical signals during said coarse adjustment and, said monitoring including continuously comparing power of said short wavelength optical signals against a first power threshold during said coarse adjustment,
wherein said first power monitor circuit adjusts said peaked passband function of said first optical filter from said first range of wavelengths to said second range of wavelengths when said first power threshold is not met during said coarse adjustment.

8. The dispersion compensation system for an optical system as claimed in claim 7, further comprising:
second power monitor circuit responsive to said second control signal for monitoring power of said short wavelength optical signals during said fine adjustment, said first power monitor circuit generates said second control signal for initiating fine adjustment of said short wavelength optical signals when power of said short wavelength optical signals becomes greater than said first power threshold during said coarse adjustment.

9. The dispersion compensation system for an optical system as claimed in claim 8, wherein said monitoring power of said short wavelength optical signals during said fine adjustment includes comparing power of said short wavelength optical signals against a second power threshold during said fine adjustment,
said second power monitor circuit adjusting said peaked passband function of said second optical filter from said narrow range of wavelengths within said first range to a narrower wavelength range within said second range of wavelengths when said second power threshold is not met during said fine adjustment.

10. The dispersion compensation system for an optical system as claimed in claim 9, wherein said peaked passband function of said second optical filter from is maintained in its wavelength range when said second power threshold is met during said fine adjustment.

11. The dispersion compensation system for an optical system as claimed in claim 2, wherein said converting mechanism is a photodetector device comprising:
a first p-i-n diode for converting a portion of dither modulated first output short wavelength optical signals into said first electric feedback signal and,
a second p-i-n diode for converting a portion of dither modulated second output short wavelength optical signals into said second electric feedback signal.

12. The dispersion compensation system for an optical system as claimed in claim 2, wherein said device for comparing includes a mixer capable of combining a selected first or second feedback signal with said sinusoidal dither modulation signal and generating a respective cross-product signal having components representing a sum and difference at dither frequencies during a respective coarse and fine adjustment.

13. The dispersion compensation system for an optical system as claimed in claim 12, wherein said wavelength-locked loop servo-control circuit further comprises:
low-pass filter device for filtering said output cross-product signal; and
integrator circuit for averaging said output cross-product signal to generate said error signal during respective coarse and fine adjustment, whereby said error signal is positive or negative depending on whether said center wavelength of one of said short wavelength optical signals are to be respectively increased or decreased during a respective coarse or fine adjustment.

14. A method to compensate for optical signal dispersion of short wavelength optical signal being communicated via a fiber optic link in an optical system, said short wavelength optical signal characterized as having an operating center wavelength, said method comprising the steps of:
a) providing an optical signal capable of being communicated via said fiber optic link in said system;
b) providing a first optical filter element having a peaked passband function capable of passing short wavelength optical signals within a first range of wavelengths;
c) enabling real time alignment of a peaked center wavelength of said short wavelength optical signals with said peaked passband function of said first optical filter element to thereby provide coarse adjustment of said short wavelength optical signals; and,
d) providing a second optical filter element having a peaked passband function capable of passing short wavelength optical signals within a narrower wavelength range within said first range of wavelengths; and,
e) enabling real time alignment of a peaked center wavelength of said coarse adjusted short wavelength optical signals with said peaked passband function of said second optical filter element to thereby provide fine adjustment of said short wavelength optical signals within said narrower wavelength range, said fine adjusted short wavelength optical signals capable of being transmitted over longer distances with reduced dispersion effects.

15. The method as claimed in claim 14, wherein said steps c) and e) of enabling real-time adjustment further comprises the steps of:
applying a dither modulation signal at a dither modulation frequency to said short wavelength optical signal to generate a dither modulated shortwave optical signal through said first adjustable optical filter element;
converting a portion of dither modulated short wavelength optical signals to be coarse adjusted into a first electric feedback signal and for converting a portion of dither modulated short wavelength optical signals to be fine adjusted into a second electric feedback signal;
responding to a first control signal for selecting said first electric feedback signal when performing a coarse adjustment and, responding to a second control signal for selecting said second electric feedback signal when performing said fine adjustment;
continuously comparing a selected first or second feedback signal with said dither modulation signal and generating a respective error signal, said error signal representing one of a difference between a frequency characteristic said selected first feedback signal and a dither modulation frequency when performing coarse adjustment of said short wavelength optical signals, or, a difference between a frequency characteristic of said selected second feedback signal and said dither modulation frequency when performing fine adjustment of said short wavelength optical signals; and,
adjusting the peak spectrum function of said short wavelength optical signal according to said error signal, wherein said center wavelength of said short wavelength optical signals are adjusted for maximum power transmission through said respective first and second optical filter elements.

16. The method as claimed in claim 15, wherein said steps c) and e) of enabling real-time alignment includes respectively, automatically adjusting said center wavelength of said short wavelength optical signals until said frequency characteristic of said first feedback signal is two times said dither modulation frequency during said coarse adjusted and, automatically adjusting said center wavelength of said fine adjusted short wavelength optical signals until said frequency characteristic of said second feedback signal is two times said dither modulation frequency.

17. The method as claimed in claim 15, wherein said short wavelength optical signal is a laser signal, said step a) of providing an optical signal capable comprising:
providing a short wavelength laser diode device; and,
inputting a bias signal to said short wavelength laser diode device for generating said short wavelength optical signal.

18. The method as claimed in claim 17, wherein said step of applying a dither modulation signal includes: modulating said bias signal with a sinusoidal dither modulation signal of a predetermined frequency.

19. The method as claimed in claim 15, wherein said first optical filter element is adjustable to provide a peaked passband function capable of passing short wavelength optical signals within a second range of wavelengths during said coarse adjustment; and, said second optical filter element is adjustable to provide a peaked passband function capable of passing short wavelength optical signals within a narrower wavelength range within said second range of wavelengths during said fine adjustment.

20. The method as claimed in claim 19, further comprising the steps of:
monitoring power of said short wavelength optical signals during said coarse adjustment by continuously comparing said power of short wavelength optical signals against a first power threshold during said coarse adjustment, said adjusting; and,
adjusting said peaked passband function of said first optical filter from said first range of wavelengths to said second range of wavelengths when said first power threshold is not met during said coarse adjustment.

21. The method as claimed in claim 20, further comprising the step of:
generating said second control signal for initiating fine adjustment of said short wavelength optical signals when said power of said short wavelength optical signals becomes greater than said first power threshold during said coarse adjustment.

22. The method as claimed in claim 21, further comprising the step of:
monitoring power of said short wavelength optical signals during said fine adjustment by continuously comparing power of said short wavelength optical signals against a second power threshold during said fine adjustment; and,
adjusting said peaked passband function of said second optical filter from said narrow range of wavelengths within said first range to a narrower wavelength range within said second range of wavelengths when said second power threshold is not met during said fine adjustment.

23. The method as claimed in claim 22, wherein said peaked passband function of said second optical filter is maintained in its wavelength range when said second power threshold is met during said fine adjustment.

24. The method as claimed in claim 15, wherein said continuously comparing step further comprises the step of:
combining a selected first or second feedback signal with said sinusoidal dither modulation signal and generating a respective cross-product signal having components representing a sum and difference at dither frequencies during a respective coarse and fine adjustment;
filtering said output cross-product signal; and
averaging said output cross-product signal to generate said error signal, said error signal being positive or negative depending on whether a center wavelength of said short wavelength optical signal is respectively less than or greater than said peaked passband function of said first optical filter element during said coarse adjustment; or, whether a center wavelength of said short wavelength optical signal is respectively less than or greater than said peaked passband function of said second optical filter element during said fine adjustment.

25. A dispersion compensation system for an optical system comprising:
a short wavelength optical signal generator for providing an optical signal capable of being communicated via a fiber optic link in an optical network, said optical signal characterized as having an operating center wavelength;
configuration of optical filter elements each having a peaked passband function capable of passing short wavelength optical signals, said optical filter elements in a nested configuration with a first optical filter element having a peaked passband function capable of passing short wavelength optical signals within a first range of wavelengths for input to a next successive optical filter stage; each successive optical filter stage of said nested configuration capable of passing wavelengths within successively narrower wavelength ranges within said first range of wavelengths;
a wavelength-locked loop servo-control circuit for enabling real time alignment of a peaked center wavelength of said short wavelength optical signals with said peaked passband function of said first optical filter element of said nested configuration to thereby provide coarse adjustment of said short wavelength optical signals, and iteratively enabling real time alignment of a peaked center wavelength of said short wavelength optical signals coarse adjusted at each optical filter stage with a peaked passband function of each an immediate successive optical filter element in the next optical filter stage of said nested configuration thereby enabling continuous fine tune adjustment of said short wavelength optical signals within successively narrower wavelength ranges, wherein a fine adjusted short wavelength optical signal output of optical filter stage is capable of being transmitted over longer optical fiber link distances with reduced dispersion effects.

26. The dispersion compensation system for an optical system as claimed in claim 25, wherein said wavelength-locked loop servo-control circuit comprises:
a mechanism for applying a dither modulation signal at a dither modulation frequency to said short wavelength optical signal to generate a dither modulated shortwave optical signal through said first adjustable optical filter element;
a mechanism for converting a portion of dither modulated short wavelength optical signals to be coarse adjusted into a first electric feedback signal and for converting a portion of each dither modulated short wavelength optical signal adjusted at each optical filter stage to be fine adjusted into a respective successive electric feedback signals;
a gate device responsive to a control signal for selecting said first electric feedback signal when performing a coarse adjustment and, responsive to a successive control signal for selecting one of successive electric feedback signals when performing said fine adjustment at each real-time alignment iteration of said wavelength-locked loop servo-control circuit;
mechanism for continuously comparing a selected first or successive electric feedback signal with said dither modulation signal and generating a respective error signal, said error signal representing one of a difference between a frequency characteristic said selected first feedback signal and a dither modulation frequency when performing coarse adjustment of said short wavelength optical signals, or, a difference between a frequency characteristic of said selected successive feedback signal and said dither modulation frequency when performing successive fine adjustment of said adjusted short wavelength optical signals output of each filter stage when performing said adjustment at each real-time alignment iteration of said wavelength-locked loop servo-control circuit; and,
mechanism responsive to an error signal for adjusting the peak spectrum function of said short wavelength optical signal according to said error signal, wherein said center wavelength of said short wavelength optical signals are adjusted for maximum power transmission through said respective first and successive optical filter elements of said nested configuration.

27. The dispersion compensation system for an optical system as claimed in claim 26, further comprising:
one or more power monitor circuits in correspondence with each optical filter stage, each power monitor circuit responsive to a control signal for monitoring power of a respective said short wavelength optical signal output from its corresponding optical filter stage, said monitoring including continuously comparing power of said short wavelength optical signals against a respective power thresholds during center wavelength adjustment at each iteration.

28. The dispersion compensation system for an optical system as claimed in claim 27, wherein each power monitor circuit includes mechanism for respectively generating a control signal for input to a succeeding stage to initiate power monitoring of short wavelength optical signals at each successive optical filter stage of said nested configuration, said mechanism generating a control signal when power of said short wavelength optical signals at the filter stage becomes greater than a power threshold set at that optical filter stage, said wavelength-locked loop servo-control circuit responsive to a control signal generated for iteratively enabling said fine tune adjustment.

29. A method of compensating for optical signal dispersion of short wavelength optical signals being communicated via a fiber optic link in an optical system, said short wavelength optical signal characterized as having an operating center wavelength, said method comprising the steps of:
a) providing an optical signal capable of being communicated via said fiber optic link in said optical system:
b) providing a plurality of optical filter elements each having a peaked passband function capable of passing short wavelength optical signals, said optical filter elements in a nested configuration with a first optical filter element having a peaked passband function capable of passing short wavelength optical signals within a first range of wavelengths for input to a next successive optical filter stage; each successive optical filter stage of said nested configuration capable of passing wavelengths within successively narrower wavelength ranges within said first range of wavelengths;
c) enabling first real time alignment of a peaked center wavelength of said short wavelength optical signals with said peaked passband function of said first optical filter element of said nested configuration to thereby provide coarse adjustment of said short wavelength optical signals; and
d) iteratively enabling real time alignment of a peaked center wavelength of said short wavelength optical signals coarse adjusted at each optical filter stage with a peaked passband function of each an immediate successive optical filter element in the next optical filter stage of said nested configuration thereby enabling continuous fine tune adjustment of said short wavelength optical signals within successively narrower wavelength ranges, wherein a fine adjusted short wavelength optical signal output of optical filter stage is capable of being transmitted over longer optical fiber link distances with reduced dispersion effects.

30. The method as claimed in claim 29, wherein said steps c) and d) of enabling real-time adjustment further comprises the steps of:
applying a dither modulation signal at a dither modulation frequency to said short wavelength optical signal to generate a dither modulated shortwave optical signal through said first adjustable optical filter element;
converting a portion of dither modulated short wavelength optical signals to be coarse adjusted into a first electric feedback signal and for converting a portion of dither modulated short wavelength optical signals at each successive optical filter stage to be fine adjusted into successive electric feedback signals;
responding to a first control signal for selecting said first electric feedback signal when performing a coarse adjustment and, responding to a successively generated control signal for selecting a respective successive electric feedback signal when performing said fine adjustment;
at each iteration, continuously comparing a selected successive electric feedback signal with said dither modulation signal and generating a respective error signal, said error signal representing one of a difference between a frequency characteristic said selected feedback signal and a dither modulation frequency when performing adjustment of said short wavelength optical signals at each iteration; and,
adjusting the peak spectrum function of said short wavelength optical signal according to said error signal, wherein said center wavelength of said short wavelength optical signals are adjusted for maximum power transmission through each successive optical filter stage at each iteration.

31. The method as claimed in claim 30, further comprising the step of:
successively monitoring power of a respective said short wavelength optical signal output from its corresponding optical filter stage in response to a respective control signal at each iteration, said monitoring including continuously comparing power of said short wavelength optical signals against a respective power thresholds during center wavelength adjustment at each iteration.

32. The method as claimed in claim 31, wherein said successively monitoring power step further comprises the step of:
generating a respective control signal for input to a succeeding stage to initiate power monitoring of short wavelength optical signals at each successive optical filter stage of said nested configuration, said control signal generated when power of said short wavelength optical signals at the filter stage becomes greater than a power threshold set at that optical filter stage, said step d) of iteratively enabling real time alignment including responding to each said control signal generated.
